(19) United States
(12) Patent Application Publication
(10) Pub. No.: US 2016/0185636 A1
(43) Pub. Date: Jun. 30, 2016

(54) COMPOSITION CONTAINING AN AA - AMPS COPOLYMER AND PMA, AND USES THEREOF

(71) Applicants: Deepak A. Musale, Aurora, IL (US); Benjamin Bingjia Yao, Shanghai (CN)

(72) Inventors: Deepak A. Musale, Aurora, IL (US); Benjamin Bingjia Yao, Shanghai (CN)

(73) Assignee: Nalco Company, Naperville, IL (US)

(21) Appl. No.: 13/697,723

(22) PCT Filed: Apr. 22, 2011
(86) PCT No.: PCT/US11/33533

§ 371 Date: Jan. 22, 2013

(30) Foreign Application Priority Data
May 14, 2010 (CN) 201010175200.2

(51) Int. Cl. C02F 5/10; C02F 1/44; C02F 1/66; C08L 33/02

(52) U.S. Cl. CPC C02F 5/10; C08L 33/02; C02F 1/44; C02F 1/66

(57) ABSTRACT

A composition and method of inhibiting scale formation and deposition from a feed stream passing through a membrane system is disclosed. The composition that is used to inhibit scale formation includes a composition containing an AA-AMPS copolymer and PMA.

### REFERENCE TO RELATED APPLICATION

This application is a continuation-in-part of U.S. Ser. No. 12/204,488, which is herein incorporated by reference in its entirety.

### FIELD OF THE INVENTION

This invention pertains to a composition(s) and method(s) of inhibiting scale formation and deposition in membrane systems.

### BACKGROUND

Nanofiltration (NF), Reverse Osmosis (RO), Electrodialysis (ED), Electrodeionization (EDI) and Membrane Distillation (MD) membrane processes have been used for the treatment of brackish (ground and surface) water, seawater and treated wastewater. During the concentration process, the solubility limits of sparingly soluble salts such as sulfates of calcium, barium, magnesium and strontium; carbonates of calcium, magnesium, barium; and phosphates of calcium, are exceeded, resulting in scale formation on a membrane surface as well as in the system. Membrane scaling results in the loss of permeate flux through the membrane, increase in salt passage through the membrane, and increase in pressure drop across membrane elements. All of these factors result in a higher operating cost of running the above-mentioned processes and a loss of water production through these membrane systems.

Antiscalants are successfully used either alone or in conjunction with a pH adjustment (in case of carbonate and phosphate scales) to inhibit scale formation. Most of the commercial antiscalants used e.g. in NF and RO processes are polyacrylates, organo-phosphonates, acrylamide copolymers and/or their blends.

Due to increasingly stringent regulations in different parts of the world including China, USA, Europe, Australia and Middle East on use of phosphorous-based materials (as they cause algal blooms in the water bodies where e.g. RO concentrate is discharged), phosphorous-free antiscalants are now required. While inorganic cations such as Zn are known to inhibit CaCO₃ scale formation, they also pose environmental concerns. Polyacrylates do not work well in presence of iron and are known to contribute to biofouling in RO system. Therefore, there is a need for developing other phosphorous free antiscalants for NF, RO, ED, EDI and MD processes.

### SUMMARY OF INVENTION

The present invention discloses a composition comprising: an AA-AMPS copolymer and PMA.

The present invention also discloses a method of inhibiting scale formation and deposition from a feed stream passing through a membrane system which comprises the steps of: (a) optionally controlling the pH of said feed stream within the range between about 7.0 and about 10; (b) optionally controlling the temperature of said feed stream within the range between about 5° C. to about 40° C. when the membrane system is an RO system, a NF system, an ED system, an EDI system or a combination thereof; (c) optionally controlling the temperature of said feed stream within the range between about 40° C. and about 80° C. when the membrane system is an MD system; and (d) adding an effective amount of a composition comprising: an AA-AMPS copolymer and PMA.
a. The present invention further discloses a method of inhibiting calcium carbonate scale formation and deposition from a feed stream passing through a membrane system which comprises the steps of: (a) optionally controlling the pH of said feed stream within the range
   between about 7.0 and about 10; (b) optionally controlling the temperature of said feed stream within the range between about 5° C. to about 40° C. when the membrane system is an RO system, a NF system, an ED system, an EDI system or a combination thereof; (c) optionally controlling the temperature of said feed stream within the range between about 40° C. and about 80° C. when the membrane system is an MD system; and (d) adding an effective amount of a composition comprising: an AA-AMPS copolymer and PMA.

### BRIEF DESCRIPTION OF THE DRAWINGS

FIG. 1 shows solution turbidity (a) and percentage (%) inhibition (b) of CaCO₃ precipitate formation for relatively simple Type I water.

FIG. 2 shows solution turbidity (a) and % inhibition (b) of CaCO₃ precipitate formation for relatively complex Type II water.

FIG. 3 shows solution turbidity for control, Product D and phosphonate product E (for comparison) for Type III water which contains silica as well as 0.8 ppm Fe³⁺.

### DETAILED DESCRIPTION OF THE INVENTION

### Definitions

A “membrane system” refers to a membrane system that contains one or more of the following: an RO system and/or NF system and/or ED system and/or MD system and/or EDI system or a combination thereof. There are various components of a membrane system that would be appreciated by one of ordinary skill in the art, e.g. a specific type or combination of membranes; a feed stream; a concentrate stream; a permeate stream; one or more apparatuses for facilitating the transfer of a stream; a combination thereof, as well as other system components that would be appreciated by one of ordinary skill in the art. The target stream that is being separated/filtered could come from various sources and one of ordinary skill in the art would be able to appreciate whether a particular membrane system can achieve the desired separation/filtration of a target stream in to its components.

AA: Acrylic acid

AMPS: 2-acrylamido, 2-methyl propyl sulfonic acid

RO: reverse osmosis.

RO system: a membrane system that contains at least one reverse osmosis membrane;

NF: nanofiltration

NF system: a membrane system that contains at least one nanofiltration membrane.

ED: electrodialysis or electrodialysis reversal.

ED system: a membrane system that contains at least one apparatus capable of performing electrodialysis or electrodialysis reversal.

MD: membrane distillation.

MD system: a membrane system that contains at least one apparatus capable of performing membrane distillation.

EDI: electrodeionization.

EDI system: a membrane system that contains at least one apparatus capable of performing electrodeionization.

PMA: polymaleic acid.

PTSA: pyrene tetra sulfonic acid and/or derivatives thereof.

ATMP: Amino tris methylenephosphonate.

TDS: Total dissolved solids.

### PREFERRED EMBODIMENT

### A. Compositions

As stated above, the present invention discloses a composition comprising: an AA-AMPS copolymer and PMA.

In another embodiment, the AA-AMPS copolymer is tagged with one or more chemistries capable of being monitored by one or more analytical instruments or processes. Tagging procedures are well known to one of ordinary skill in the art, e.g. general procedures regarding tagging and the use of tagging are described in U.S. Pat. Nos. 5,171,450, 5,411,889, 6,645,428, and US Patent Publication Number 2004/0135124, which are herein incorporated by reference. In a further embodiment, the chemistries are fluorophores. In yet a further embodiment, the chemistries are capable of being monitored by absorbance spectroscopy. In yet a further embodiment, tagged chemistries contain at least the following monomer: 4-methoxy-N-(3-N′,N′-dimethylaminopropyl)naphthalimide, 2-hydroxy-3-allyloxy-propyl quaternary salt.

Various formulations containing AA-AMPS and PMA chemistries are covered by this disclosure and can be tailored to the specific needs of a treatment program of interest. One of ordinary skill in the art can manufacture the AA-AMPS copolymer and formulate the PMA with it by various means known to one of ordinary skill in the art.

In one embodiment, the AA-AMPS copolymer is 5-40 weight percent based upon actives and PMA is 5-40 weight percent based upon actives.

In another embodiment, the AA-AMPS copolymer is 13 weight percent based upon actives and PMA is 18 weight percent based upon actives.

In another embodiment, one or more fluorophores can be added to the AA-AMPS and PMA formulation. Examples of fluorophores include, but are not limited to, PTSA, rhodamine, and fluorescein; a discussion regarding formulated fluorophores and uses thereof can be found in U.S. Pat. Nos. 4,783,314, 4,992,380, 6,645,428, and 6,255,118, and U.S. Patent Publication No. 2006/0246595. In a further embodiment, PTSA is 0.1-0.8 weight percent based upon actives. One of ordinary skill in the art would be able to determine the amount of fluorophore needed in the formulation without undue experimentation. In yet a further embodiment, a copolymer that is tagged with one or more chemistries capable of being monitored by one or more analytical instruments or processes is formulated with the composition containing said fluorophore, e.g. PTSA.

In another embodiment, the comonomers AA and AMPS may be in acid form or salt form in the copolymer.

In another embodiment, the AA-AMPS copolymer has a molar ratio between AA and the AMPS comonomers of 80:20.

In another embodiment, the AA-AMPS copolymer has a molar ratio between AA and the AMPS comonomers of 60:40.

In another embodiment, the composition excludes one or more phosphorous compounds.

In another embodiment, the AA-AMPS copolymer has a molar ratio between AA and the AMPS comonomers of 2:98 to 98:2.

In another embodiment, the AA-AMPS copolymer has a weight average molecular weight of about 1,000 to about 100,000 Daltons.

In another embodiment, the PMA may be manufactured by water process or organic solvent (oil) process.

In another embodiment, the PMA has a molecular weight of 400-50,000 Daltons.

### B. Methods

The above-mentioned compositions can be applied to the following methods.

As stated above, the present invention provides for a method of inhibiting scale formation and deposition from a feed stream passing through a membrane system, which comprises the steps of: (a) optionally controlling the pH of said feed stream within the range between about 7.0 and about 10; (b) optionally controlling the temperature of said feed stream within the range between about 5° C. to about 40° C. when the membrane system is an RO system, a NF system, an ED system, an EDT system or a combination thereof: (c) optionally controlling the temperature of said feed stream within the range between about 40° C. and about 80° C. when the membrane system is an MD system; and (d) adding an effective amount of a composition comprising: an AA-AMPS copolymer and PMA.

In another embodiment, the scale is made up of calcium carbonate. In a further embodiment, the scale excludes calcium sulfate, calcium phosphate, calcium fluoride and/or barium sulfate.
b. In another embodiment, the present invention further discloses a method of inhibiting calcium carbonate scale formation and deposition from a feed stream passing through a membrane system which comprises the steps of: (a) optionally controlling the pH of said feed
   stream within the range between about 7.0 and about 10; (b) optionally controlling the temperature of said feed stream within the range between about 5° C. to about 40° C. when the membrane system is an RO system, a NF system, an ED system, an EDI system or a combination thereof; (c) optionally controlling the temperature of said feed stream within the range between about 40° C. and about 80° C. when the membrane system is an MD system; and (d) adding an effective amount of a composition comprising: an AA-AMPS copolymer and PMA.

The feed stream can have various types of constituents, in particular, varying amounts of total dissolved solids (TDS).

In one embodiment, the TDS of the feed stream is between 200-40,000 ppm.

In another embodiment, the TDS of the feed stream is between 200-20,000 ppm.

The amount of composition, e.g. formulation of AA-AMPS and PMA alone or with other chemistries, and the manner in which the composition is added to a feed stream can depend on the target feed stream of interest. One of ordinary skill in the art would be able to select the appropriate chemistry without undue experimentation.

In one embodiment, the composition added to the feed stream contains a formulation containing AA-AMPS copolymer and PMA. The formulation is added to the feed stream by one or more feeding protocols known to those of ordinary skill in the art. In another embodiment, AA-AMPS and PMA can be added separately with feed stream circumstances taken into account by one of ordinary skill in the art.

Various compositions containing AA-AMPS and PMA can be added to the feed stream. In one embodiment, the AA-AMPS copolymer is tagged with one or more chemistries capable of being monitored by one or more analytical instruments or processes. Tagging procedures are well known to one of ordinary skill in the art, e.g. general procedures regarding tagging and the use of tagging are described in U.S. Pat. Nos. 5,171,450, 5,411,889, 6,645,428, 7,601,789, 7,148,351 and US Patent Publication Number 2004/0135124, which are herein incorporated by reference. In a further embodiment, the tagged chemistries are fluorophores. In yet a further embodiment, tagged chemistries contain at least the following monomer: 4-methoxy-N-(3-N′,N′-dimethylaminopropyl)naphthalimide, 2-hydroxy-3-allyloxy-propyl quaternary salt.

Various formulations of AA-AMPS and PMA containing compositions are covered by this invention and the composition formulations can be tailored to the specific needs of a treatment program of interest—in this case, the target feed stream of interest. One of ordinary skill in the art can manufacture the AA-AMPS copolymer and formulate the PMA with it by various means known to one of ordinary skill in the art.

In one embodiment, the AA-AMPS copolymer is 5-40 weight percent based upon actives and PMA is 5-40 weight percent based upon actives.

In another embodiment, the AA-AMPS copolymer is 13 weight percent based upon actives and PMA is 18 weight percent based upon actives.

In another embodiment, one or more chemistries can be added to the formulation In another embodiment, one or more fluorophores can added to the AA-AMPS and PMA formulation. Examples of fluorophores include, but are not limited to, PTSA, rhodamine, and fluorescein; a discussion regarding formulated fluorophores and uses thereof can be found in U.S. Pat. Nos. 4,783,314, 4,992,380, 6,645,428, and 6,255,118, and U.S. Patent Publication No. 2006/0246595, which are all herein incorporated by reference. In yet a further embodiment, a copolymer that is tagged with one or more chemistries capable of being monitored by one or more analytical instruments or processes is formulated with the composition containing said fluorophore, e.g. PTSA. In yet another embodiment, the fluorophore is inert in a target water system, e.g. feed stream, so as to not to be appreciably consumed by particular water system chemistries.

In a further embodiment, PTSA is 0.1-0.8 weight percent based upon actives. One of ordinary skill in the art would be able to determine the amount of fluorophore needed in the formulation without undue experimentation.

In another embodiment, the comonomers AA and AMPS may be in acid form or salt form in the copolymer.

In another embodiment, the AA-AMPS copolymer has a molar ratio between AA and the AMPS comonomers of 80:20.

In another embodiment, the AA-AMPS copolymer has a molar ratio between AA and the AMPS comonomers of 60:40.

In another embodiment, the composition excludes one or more phosphorous compounds.

In another embodiment, the AA-AMPS copolymer has a molar ratio between AA and the AMPS comonomers of 2:98 to 98:2.

In another embodiment, the AA-AMPS copolymer has a weight average molecular weight of about 1,000 to about 100,000 Daltons.

In another embodiment, the PMA may be manufactured by water process or organic solvent (oil) process.

In another embodiment, the PMA has a molecular weight of 400-50,000 Daltons.

The methodologies of the preset invention can utilize tracers to monitor and/or control the compositions applied to a feed stream/water system. A methodology involving tracers and/or tagged chemistries, tagged chemistries of AA-AMPS, may be utilized to achieve this function. A feedback control of the appropriate chemistry or a system step can be implemented in response to the chemistry in the system, e.g. feed water. Tracer chemistry protocols have been discussed in U.S. Pat. Nos. 4,783,314, 4,992,380, 6,645,428 and 6,255,118, and U.S. Patent Publication No. 2006/0246595, which are herein incorporated by reference. Tagged polymer treatment protocols have been discussed in U.S. Pat. Nos. 5,171,450, 5,411,889, 6,645,428, 7,601,789, 7,148,351 and US Patent Publication Number 2004/0135124, which are herein incorporated by reference.

In one embodiment, a fluorophore is added in known proportion to a formulation of an AA-AMPS copolymer and PMA and said method further comprises the steps of measuring the fluorescence of said fluorophore, correlating the fluorescence of the fluorophore with the concentration of the formulation of said AA-AMPS copolymer and PMA and adjusting the feed of said AA-AMPS copolymer and PMA according to one or more set point values established for the amount of AA-AMPS copolymer and PMA in said feed stream.

In another embodiment, PTSA is added in known proportion to a formulation of an AA-AMPS copolymer and PMA and said method further comprises the steps of measuring the fluorescence of said PTSA, correlating the fluorescence of the PTSA with the concentration of the formulation of said AA-AMPS copolymer and PMA and adjusting the feed of said AA-AMPS copolymer and PMA according to one or more set point values established for the amount of AA-AMPS copolymer and PMA in said feed stream. In another embodiment, other appropriate tracers, e.g. fluorophores may be utilized.

In another embodiment, the copolymer is tagged with a fluorophore and optionally wherein the fluorescence of said fluorophore is determined in said feed stream and optionally wherein the fluorescence of the said tagged copolymer is correlated with the concentration of the tagged copolymer and optionally adjusting the feed of said AA-AMPS copolymer and PMA according to one or more set point values established for the amount of AA-AMPS copolymer and PMA in said feed stream determined through the fluorescence of said tagged co-polymer.

In another embodiment, a copolymer is tagged with a fluorophore and optionally wherein the fluorescence of said fluorophore is determined in said feed stream and optionally wherein the fluorescence of the said tagged copolymer is correlated with the concentration of the tagged copolymer and optionally adjusting the feed of said AA-AMPS copolymer and PMA according to one or more set point values established for the amount of AA-AMPS copolymer and PMA in said feed stream determined through the fluorescence of said tagged co-polymer.

In another embodiment, the flurophore/PTSA feed back control protocol can be combined with the tagged treatment protocol in order to get a better understanding of the concentration of a composition containing AA-AMPS and PMA so that system conditions such as scaling potential can be assessed and/a response protocol can be designed and implemented.

### EXAMPLES

The performance of CaCO₃ scale inhibition was determined with individual polymers (PMA and AA-AMPS copolymer) and their mixture in jar tests. The scale inhibitor formulations are shown in Table 1. The total active polymer concentration in all formulations was kept between 27-31%.

TABLE 1
Phosphorous-Free (A-D) and Phosphonate (E) based
Scale Inhibitor Formulations (wt % on active basis)

| | Product A | Product B | Product C | Product D | Product E |
|---|---|---|---|---|---|
| PMA | 27 | | 18 | 18 | |
| AA-AMPS | | 27 | 13 | 12.5 | |
| Copolymer | | | | | |
| Water | 73 | 73 | 69 | 69.3 | 65.6 |
| PTSA | | | | 0.2 | |
| Na-ATMP | | | | | 34.4 |
| Total | 100 | 100 | 100 | 100 | 100 |
| Ratio of | | | ~4:3 | ~4:3 | |
| PMA:AA- | | | | | |
| AMPS | | | | | |

The water chemistries used in three different examples below are shown in Table 2. These chemistries were simulated to that of concentrates of brackish water RO systems.

TABLE 2
Water Chemistries used in three examples

| | Water I | Water II | Water III |
|---|---|---|---|
| Ion (ppm) | (Example I) | (Example II) | (Example III) |
| Na⁺ | 275 | | 1835 |
| Ca²⁺ | 355 | 130.64 | 320.6 |
| Mg²⁺ | | 25.92 | 126.4 |
| Fe³⁺ | | 0.1 | 0.8 |
| Cl⁻ | 624 | 104.4 | 1454 |
| CO₃²⁻ | | | 3.6 |
| HCO₃⁻ | 732 | 494.83 | 1366.8 |
| SO₄⁻⁻ | | 190 | 236.3 |
| SiO₂ | | | 72 |
| pH | 8.0 | 9.0 | 8.1 |
| LSI | 1.77 | 2.18 | 2.0 |

After adding the antiscalant at certain concentrations in test water in ajar, the solution was continued to stir for 2 hrs. The efficacy of scale inhibition was determined by measuring residual soluble (filtered) Ca²⁺ level in solution and/or turbidity, every 30 minutes.

### Example 1

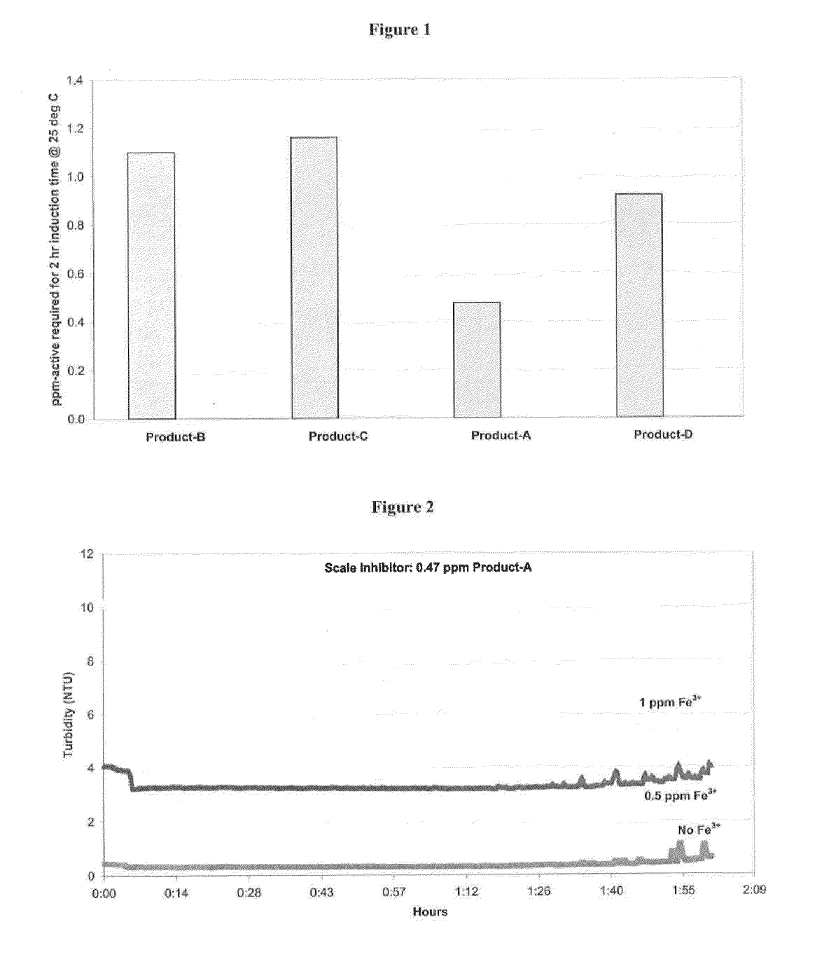

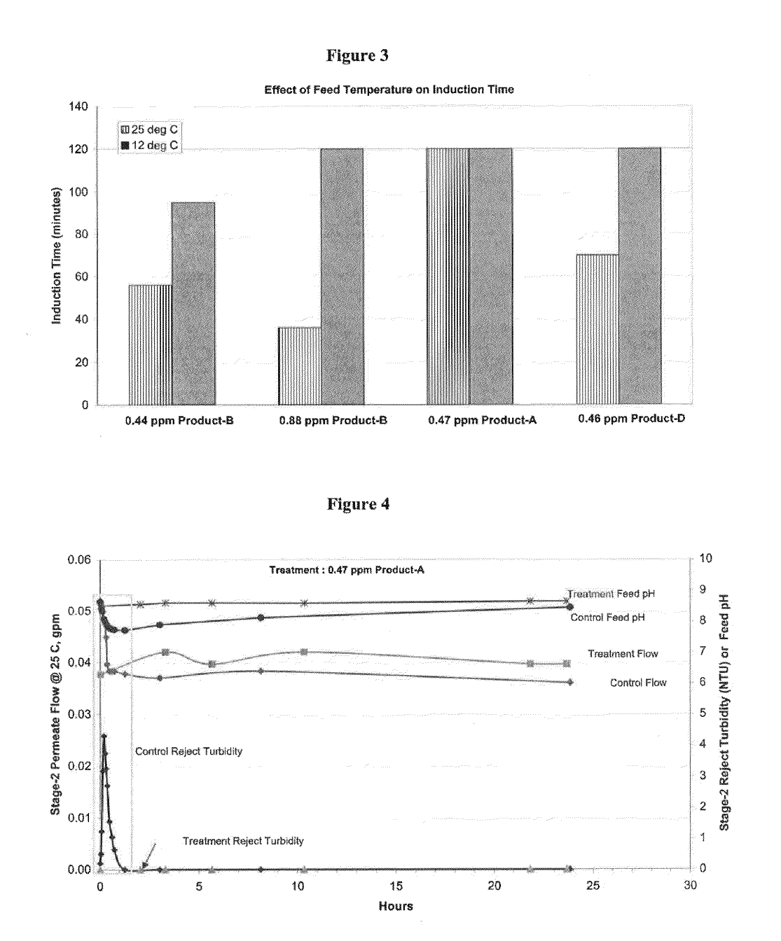

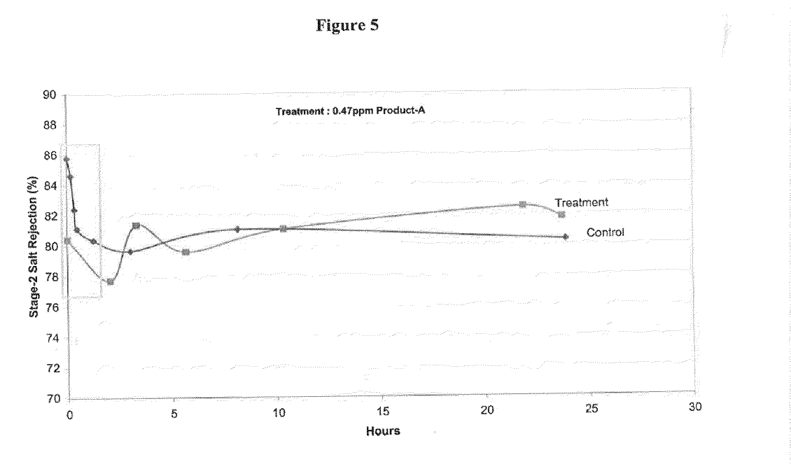

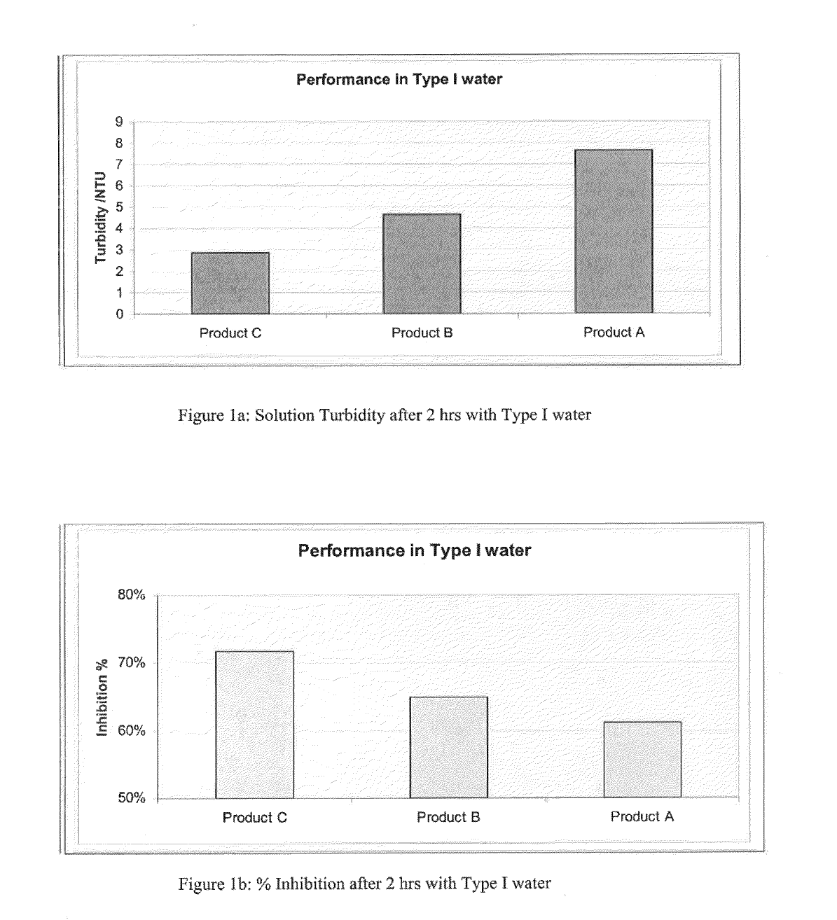

FIGS. 1a and 1b show the solution turbidity and % inhibition of CaCO₃ precipitate formation for Type I water, which is relatively simple. It is apparent that treatment with the mixture of PMA and AA-AMPS copolymer (Product C) resulted in lowest turbidity and highest % inhibition of CaCO₃ formation compared to that with PMA alone (Product A) or AA-AMPS Copolymer alone (Product B) at the same dosage (0.54 ppm as active polymer), demonstrating the synergistic effect of these polymers.

### Example 2

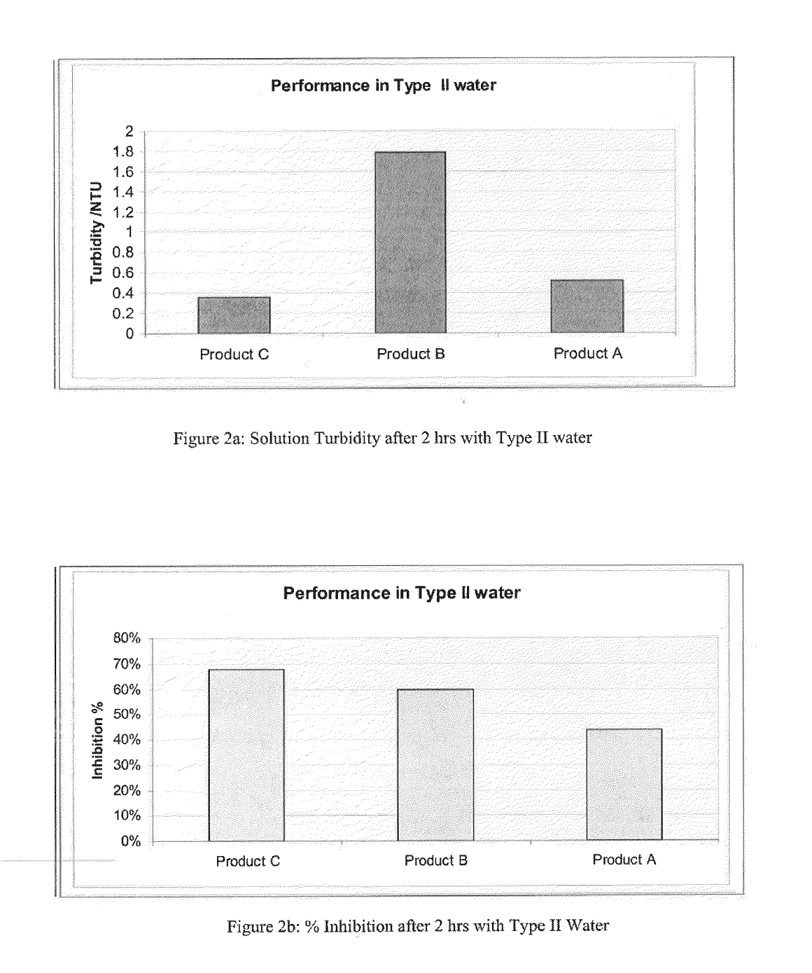

In this example, relatively complex water chemistry (Type II Water, Table 2) was used. FIGS. 2a and 2b show solution turbidity and % inhibition data for this experiment. The results again demonstrate that Product C (mixture of polymers) performs better than product A (PMA) or Product B (AA-AMPS copolymer) alone, at the same dosage (0.54 ppm as active polymer).

### Example 3

In this example, Type III water was used, which contained silica (72 ppm) and Fe³⁺ (0.8 ppm)

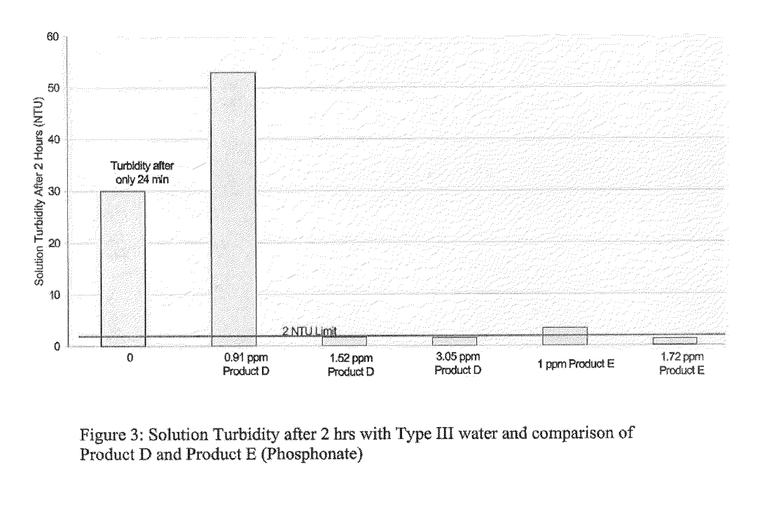

The turbidity after 2 hrs of antiscalant addition is shown in FIG. 3 for control and Product D and data is also compared with phosphonate based product E, which is one of the chemistries currently used in the industry for CaCO₃ scale control. It is apparent that with 1.5-3 ppm-active product D (Mixture of PMA and AA-AMPS copolymer), turbidity was maintained below 2 NTU even in presence of 0.8 ppm Fe³⁺. These dosages are in the same range as that required for phosphonate based product (1.72 ppm Product E).

All of the above examples demonstrate the efficacy of phosphorous-free antiscalant composition comprising PMA and AA-AMPS copolymer (Products C and D) for CaCO₃ scale control. These formulations were also found to be compatible with polyamide RO membranes, which are predominantly used in the industry.

### Combinations of Components Described in Patent Application

In one embodiment, the composition of matter claims includes various combinations of compositions, such as molar ratios of individual components. In a further embodiment, the claimed compositions include combinations of the dependent claims. In a further embodiment, a range or equivalent thereof of a particular component shall include the individual component(s) within the range or ranges within the range.

In another embodiment, the method of use claims includes various combinations of the compositions, such as molar ratios of individual components. In a further embodiment, the claimed methods of use include combinations of the dependent claims. In a further embodiment, a range or equivalent thereof of a particular component shall include the individual component(s) within the range or ranges within the range.

We claim:

1. A composition comprising: an AA-AMPS copolymer and PMA.

2. The composition of claim 1, wherein said AA-AMPS copolymer is 5 to 40 weight percent based upon actives and PMA is 5 to 40 weight percent based upon actives.

3. The composition of claim 1, wherein said AA-AMPS copolymer is 13 weight percent based upon actives and PMA is 18 weight percent based upon actives.

4. The composition of claim 1, further comprising an effective amount of a fluorophore optionally wherein said fluorophore contains at least PTSA.

5. The composition of claim 4, wherein said PTSA is 0.1 to 0.8 weight percent based upon actives.

6. The composition of claim 1, wherein said composition excludes one or more phosphorous compounds.

7. The composition of claim 1, wherein said AA-AMPS copolymer has a molar ratio between AA and the AMPS comonomers of 2:98 to 98:2.

8. The composition of claim 1, wherein said AA-AMPS copolymer has a weight average molecular weight of about 1,000 to about 100,000 Daltons.

9. The composition of claim 1, wherein the molecular weight of PMA is from 400 to 50,000 Daltons.

10. A method of inhibiting scale formation and deposition from a feed stream passing through a membrane system which comprises the steps of:
c. optionally controlling the pH of said feed stream within the range between about 7.0 and about 10;
d. optionally controlling the temperature of said feed stream within the range between about 5° C. to about 40° C. when the membrane system is an RO system, a NF system, an ED system, an EDI system or a combination thereof;
e. optionally controlling the temperature of said feed stream within the range between about 40° C. and about 80° C. when the membrane system is an MD system; and
f. adding an effective amount of the composition of claim 1 to said feed stream

11. The method of claim 10, wherein said composition excludes one or more phosphorous compounds.

12. The method of claim 10, wherein said AA-AMPS copolymer is 5 to 40 weight percent based upon actives and PMA is 5 to 40 weight percent based upon actives.

13. The method of claim 10, wherein said AA-AMPS copolymer is 13 weight percent based upon actives and PMA is 18 weight percent based upon actives.

14. The method of claim 10, wherein the composition of claim 1 further comprises an effective amount of one or more fluorophores, optionally wherein the fluorophors contain at least PTSA.

15. The method of claim 10, wherein said effective amount of said composition is from about 0.01 ppm to about 30 ppm based upon polymer actives.

16. The method of claim 10, wherein molecular weight of PMA is 400 to 50,000 Daltons

17. A method of inhibiting calcium carbonate scale formation and deposition from a feed stream passing through a membrane system which comprises the steps of:
a. a. optionally controlling the pH of said feed stream within the range between about 7.0 and about 10;
b. optionally controlling the temperature of said feed stream within the range between about 5° C. to about 40° C. when the membrane system is an RO system, a NF system, an ED system, an EDI system or a combination thereof;
c. optionally controlling the temperature of said feed stream within the range between about 40° C. and about 80° C. when the membrane system is an MD system; and
d. adding an effective amount of the composition of claim 1 to said feed stream.

18. The method of claim 10, wherein the TDS of feed stream is between 200 to 40,000 ppm.

19. The method of claim 10, wherein the TDS of feed stream is between 200 to 20,000 ppm.

20. The method of claim 14, wherein PTSA is added in known proportion to a formulation of an AA-AMPS copolymer and PMA and said method further comprises the steps of measuring the fluorescence of said PTSA, correlating the fluorescence of the PTSA with the concentration of the formulation of said AA-AMPS copolymer and PMA and adjusting the feed of said AA-AMPS copolymer and PMA according to one or more set point values established for the amount of AA-AMPS copolymer and PMA in said feed stream.

21. The method of claim 20, wherein the copolymer is tagged with a fluorophore and optionally wherein the fluorescence of said fluorophore is determined in said feed stream and optionally wherein the fluorescence of the said tagged copolymer is correlated with the concentration of the tagged copolymer and optionally adjusting the feed of said AA-AMPS copolymer and PMA according to one or more set point values established for the amount of AA-AMPS copolymer and PMA in said feed stream determined through the fluorescence of said tagged co-polymer.

22. The method of claim 10, wherein a fluorphore is added in known proportion to a formulation of an AA-AMPS copolymer and PMA and said method further comprises the steps of measuring the fluorescence of said fluorophore, correlating the fluorescence of the fluorophore with the concentration of the formulation of said AA-AMPS copolymer and PMA and adjusting the feed of said AA-AMPS copolymer and PMA according to one or more set point values established for the amount of AA-AMPS copolymer and PMA in said feed stream.

23. The method of claim 10, wherein the copolymer is tagged with a fluorophore and optionally wherein the fluorescence of said fluorophore is determined in said feed stream and optionally wherein the fluorescence of the said tagged copolymer is correlated with the concentration of the tagged copolymer and optionally adjusting the feed of said AA-AMPS copolymer and PMA according to one or more set point values established for the amount of AA-AMPS copolymer and PMA in said feed stream determined through the fluorescence of said tagged co-polymer.

24. The method of claim 22, wherein the copolymer is tagged with a fluorophore and optionally wherein the fluorescence of said fluorophore tagged to said copolymer is determined in said feed stream and optionally wherein the fluorescence of the said tagged copolymer is correlated with the concentration of the tagged copolymer and optionally adjusting the feed of said AA-AMPS copolymer and PMA according to one or more set point values established for the amount of AA-AMPS copolymer and PMA in said feed stream determined through the fluorescence of said tagged co-polymer.

25. The composition of claim 1, wherein said copolymer is tagged with one or more chemistries capable of being monitored by one or more analytical instruments or processes.

26. The composition of claim 25, wherein said chemistries are fluorophores.

27. The composition of claim 25, wherein the tagged chemistries contains at least the following monomers: 4-methoxy-N-(3-N′,N′-dimethylaminopropyl)naphthalimide, 2-hydroxy-3-allyloxy-propyl quaternary salt

28. The composition of claim 4, further comprising a copolymer that is tagged with one or more chemistries capable of being monitored by one or more analytical instruments or processes.
